(19) United States
(12) Patent Application Publication
(10) Pub. No.: US 2020/0039184 A1
(43) Pub. Date: Feb. 6, 2020

(54) COMPOSITE MIDDLE FRAME OF ELECTRONIC COMMUNICATION DEVICE

(71) Applicants: SHENZHEN FUTAIHONG PRECISION INDUSTRY CO., LTD., Shenzhen (CN); FIH (HONG KONG) LIMITED, Kowloon (HK)

(72) Inventors: CHWAN-HWA CHIANG, New Taipei (TW); ZENG-MAO ZHENG, Shenzhen (CN)

(21) Appl. No.: 16/121,818

(22) Filed: Sep. 5, 2018

(30) Foreign Application Priority Data
Aug. 1, 2018 (CN) 201821236815.X

(51) Int. Cl. B32B 15/08; B32B 3/26; B32B 1/00; G06F 1/16

(52) U.S. Cl. CPC B32B 15/08; B32B 3/266; H04M 1/0202; G06F 1/1626; B32B 1/00

(57) ABSTRACT

A composite middle frame for use in an electronic communication device includes at least two connecting layers. Each connecting layer is an endless structure. At least one of the connecting layers is made of plastic, and the remaining connecting layers are made of metal.

### FIELD

The subject matter herein generally relates to electronic devices, and more particularly to a composite middle frame of an electronic communication device.

### BACKGROUND

Generally, an electronic communication device includes an enclosed metal middle frame which is an electrostatic screening structure. Signals of the electronic communication device generally require to be transmitted through partition strips arranged on a body of the electronic communication device. However, the partition strips negatively affect an outward appearance of the electronic communication device.

Therefore, there is room for improvement in the art.

### BRIEF DESCRIPTION OF THE DRAWINGS

Implementations of the present disclosure will now be described, by way of example only, with reference to the attached figures.

FIG. 1 is an isometric view of a composite middle frame of an electronic communication device in accordance with the present disclosure.

FIG. 2 is a cross-sectional view taken along line II-II in FIG. 1.

FIG. 3 is an isometric view of a composite middle frame of an electronic communication device in accordance with the present disclosure.

FIG. 4 is a cross-sectional view taken along line IV-IV in FIG. 3.

FIG. 5 is an isometric view of a composite middle frame of an electronic communication device in accordance the present disclosure.

FIG. 6 is a cross-sectional view taken along line VI-VI in FIG. 5.

FIG. 7 is a top view of the composite middle frame in FIG. 1, FIG. 3, and FIG. 5.

### DETAILED DESCRIPTION

It will be appreciated that for simplicity and clarity of illustration, where appropriate, reference numerals have been repeated among the different figures to indicate corresponding or analogous elements. Additionally, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “substantially” is defined to be essentially conforming to the particular dimension, shape, or other word that “substantially” modifies, such that the component need not be exact. For example, “substantially cylindrical” means that the object resembles a cylinder, but can have one or more deviations from a true cylinder. The term “comprising” means “including, but not necessarily limited to”; it specifically indicates open-ended inclusion or membership in a so-described combination, group, series and the like.

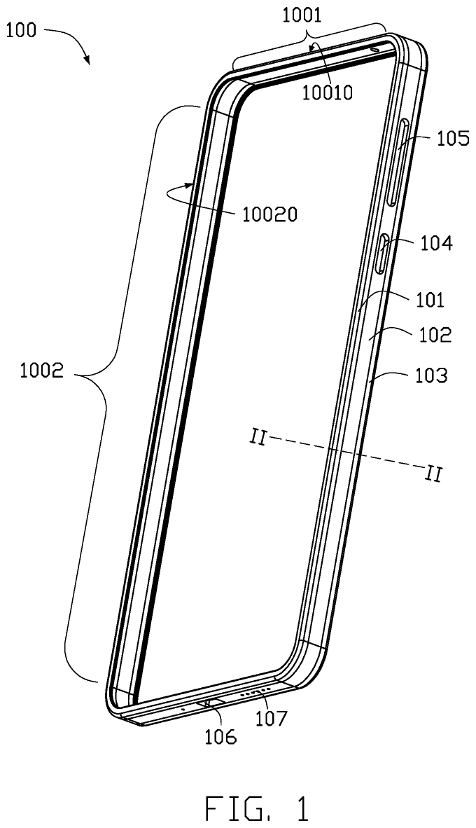

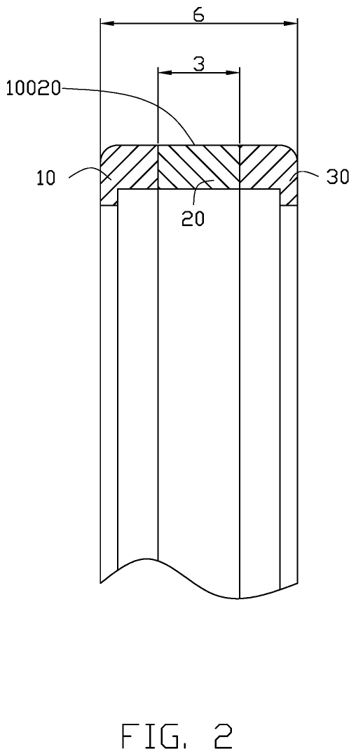

FIG. 1 and FIG. 2 show a first embodiment of a composite middle frame 100 for use in an electronic communication device (not shown). The electronic communication device may be a mobile phone, a tablet computer, a personal digital assistant, a multimedia player, or the like. The electronic communication device includes a display screen (not shown) and a back cover (not shown). The composite middle frame 100 is coupled to the display screen and the back cover. The composite middle frame 100 includes a first connecting layer 101, a second connecting layer 102, and a third connecting layer 103 layered in sequence. Each of the first connecting layer 101, the second connecting layer 102, and the third connecting layer 103 is an endless structure. None of the first connecting layer 101, the second connecting layer 102, and the third connecting layer 103 has a partitioning strip installed thereon. The first connecting layer 101 and the third connecting layer 103 are made of metal, such as aluminum alloy, stainless steel, titanium alloy, zinc alloy, magnesium alloy, liquid metal, or the like. The second connecting layer 102 is made of plastic, such as polyamide, polyphenylene sulfide, polytetramethyl terephthalate, or the like.

In at least one embodiment, the first connecting layer 101 and the third connecting layer 103 are coupled to the second connecting layer 102 by nano-injection molding. The first connecting layer 101 is coupled to the display screen of the electronic communication device, and the third connecting layer 103 is coupled to the back cover of the electronic communication device. A thickness of the first connecting layer 101 or the third connecting layer 103 is between about 0.5 mm-1.5 mm, and more preferably is about 1.5 mm. A thickness of the second connecting layer 102 is about 2.5 mm-4 mm, and more preferably about 3 mm. The second connecting layer 102 defines a charging hole 106, a speaker hole 107, a power hole 104, and a volume control button hole 105.

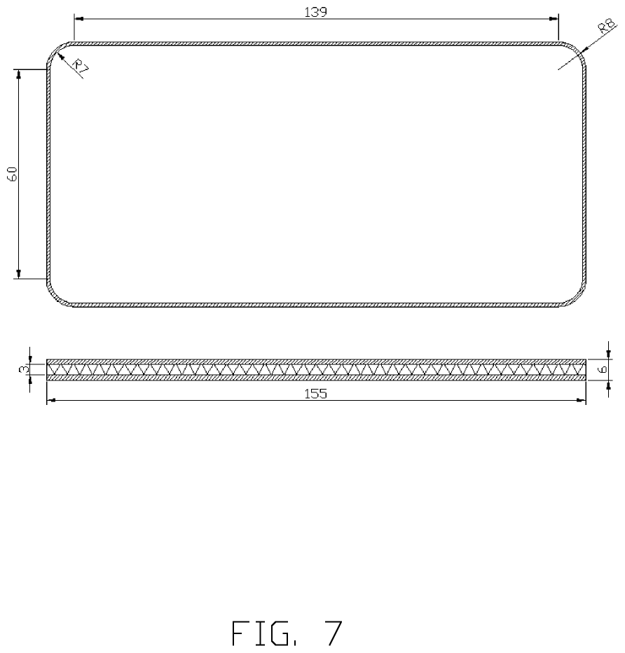

The composite middle frame 100 further includes two first side sections 1001 and two second side sections 1002. The two first side sections 1001 and the two second side sections 1002 are interconnected. The two first side sections 1001 are arranged on the outer, opposite sides of middle frame and substantially parallel to each other. The two second side sections 1002 are arranged on the outer, opposite sides of middle frame and substantially parallel to each other. Each first side section 1001 includes a first outer surface 10010 facing away from the other first side section 1001. The first outer surface 10010 extends from the first connecting layer 101 to the third connecting layer 103, and the first outer surface 10010 is substantially a flat surface (shown in FIG. 2). Each second side section 1002 includes a second outer surface 10020 facing away from the other second side section 1002. The second outer surface 10020 extends from the first connecting layer 101 to the third connecting layer 103, and the second outer surface 10020 is substantially a flat surface (shown in FIG. 2). FIG. 7 shows the first side section 1001 and the second side section 1002 are coupled together by two first arcuate corners 108 and two second arcuate corners 109. The two first arcuate corners 108 are adjacent to the charging hole 106 and have a radius of about 7 mm. The second arcuate corners have a radius of about 8 mm.

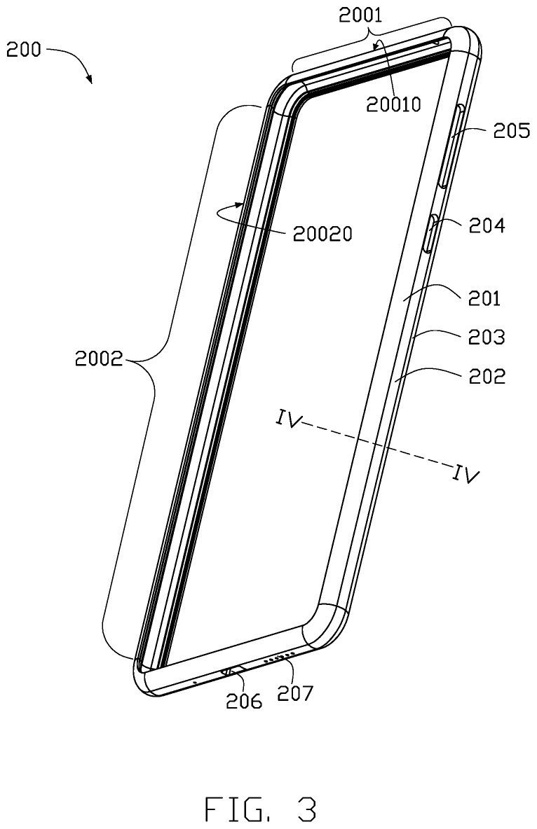

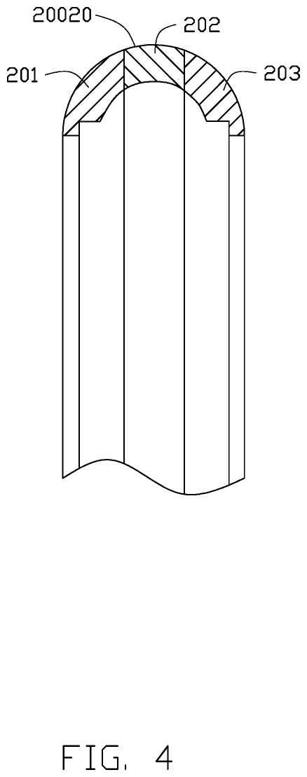

FIG. 3 and FIG. 4 show a second embodiment of a composite middle frame 200. The composite middle frame 200 is substantially similar to the composite middle frame 100, except that each first outer surface 20010 of the first side sections 2001 is a substantially cambered surface, and each second outer surface 20020 of the second side sections 2002 is a substantially cambered surface.

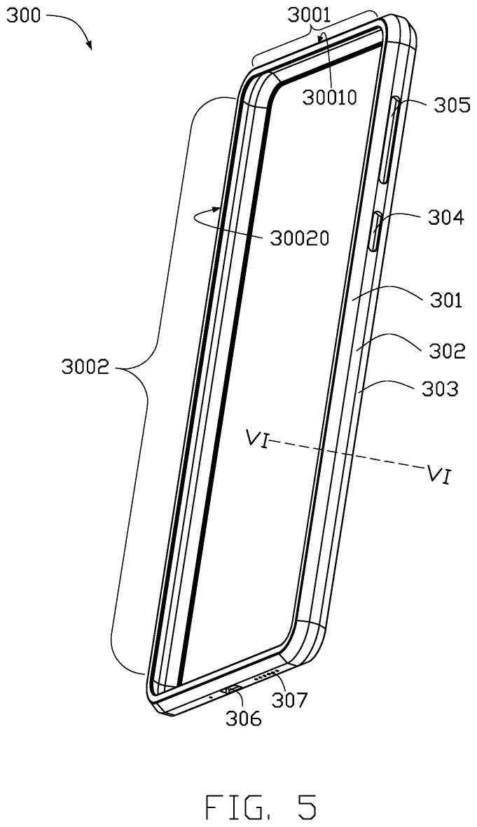

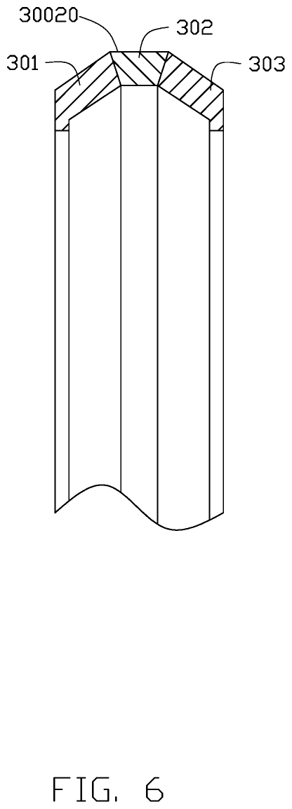

FIG. 5 and FIG. 6 show a third embodiment of a composite middle frame 300. The composite middle frame 300 is substantially similar to the composite middle frame 100, except that each first outer surface 30010 of the first side sections 3001 is a substantially prismatic surface, and each second outer surface 30020 of the second side sections 3002 is a substantially prismatic surface.

In other embodiments, the number of connecting layers 101-103 can be varied according to requirements. For example, the composite middle frame 100, 200, 300 may include one metal connecting layer and one plastic connecting layer. In other embodiments, the composite middle frame 100, 200, 300 may include two metal connecting layers and two plastic connecting layers alternately layering on each other.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

What is claimed is:

1. A composite middle frame for use in an electronic communication device, the composite middle frame comprising:
at least two connecting layers, each connecting layer being an endless structure; wherein:
at least one of the connecting layers is made of plastic; and
the remaining connecting layers are made of metal.

2. The composite middle frame of claim 1, wherein the at least two connecting layers comprise:
a first connecting layer;
a second connecting layer; and
a third connecting layer; wherein
the first connecting layer, the second connecting layer, and the third connecting layer are layered in sequence; and
both of the first connecting layer and the third connecting layer are made of metal, and the second connecting layer is made of plastic.

3. The composite middle frame of claim 2, further comprising:
two first side sections arranged on the outer, opposite sides of middle frame and parallel to each other; and
two second side sections arranged on the outer, opposite sides of middle frame and parallel to each other; wherein:
the two first side sections and the two second side sections are interconnected.

4. The composite middle frame of claim 3, wherein an outer surface of each first side section facing away from the other first side section is a flat surface; and an outer surface of each second side section facing away from the other second side section is a flat surface.

5. The composite middle frame of claim 3, wherein an outer surface of each first side section facing away from the other first side section is a cambered surface; and an outer surface of each second side section facing away from the other second side section is a cambered surface.

6. The composite middle frame of claim 3, wherein an outer surface of each first side section facing away from the other first side section is a prismatic surface; and an outer surface of each second side section facing away from the other second side section is a prismatic surface.

7. The composite middle frame of claim 3, wherein the first side sections are coupled to the second side sections by arcuate corners.

8. The composite middle frame of claim 2, wherein the second connecting layer defines at least one of a charging hole, a speaker hole, a power hole, and a volume control button hole.
